(19) United States
(12) Patent Application Publication
(10) Pub. No.: US 2024/0400879 A1
(43) Pub. Date: Dec. 5, 2024

(54) HEATING ELEMENT COMPOSITION CAPABLE OF THREE-DIMENSIONAL MOLDING, AND FILM HEATER FORMED THEREFROM

(71) Applicant: TERAON CO., LTD., Seongnam-si, Gyeonggi-do (KR)

(72) Inventors: Yoon Jin KIM, Yongin-si, Gyeonggi-do (KR); Gil Joon YOU, Hwaseong-si, Gyeonggi-do (KR); Hyung Jun KIM, Seoul (KR); Geon Hee PARK, Gunpo-si, Gyeonggi-do (KR); Bo Kyung HONG, Yongin-si, Gyeonggi-do (KR)

(73) Assignee: TERAON CO., LTD., Seongnam-si, Gyeonggi-do (KR)

(21) Appl. No.: 18/698,348

(22) PCT Filed: May 20, 2022
(86) PCT No.: PCT/KR2022/007213

§ 371 Date: Apr. 3, 2024

(30) Foreign Application Priority Data
Nov. 8, 2021 (KR) 10-2021-0152297
Nov. 9, 2021 (KR) 10-2021-0153324

(51) Int. Cl. C09K 5/14; B29C 51/00; B29C 51/10; B29C 51/26; B29C 51/30; B29K 29/00; B29K 61/04; B29K 67/00; B29K 105/16; B29K 505/00; B29K 507/04; B29L 31/00; C09D 7/20; C09D 7/61; C09D 7/65; C09D 129/14; C09D 161/12; C09D 161/16; C09D 167/06; H05B 3/14

(52) U.S. Cl. CPC C09K 5/14; B29C 51/002; C09D 7/20; C09D 7/61; C09D 7/65; C09D 129/14; C09D 161/12; C09D 161/16; C09D 167/06; H05B 3/146; B29C 51/10; B29C 51/264; B29C 51/30; B29K 2029/14; B29K 2061/04; B29K 2067/06; B29K 2105/16; B29K 2105/162; B29K 2505/00; B29K 2507/04; B29K 2995/0013; B29K 2995/0016; B29L 2031/779; H05B 2203/013; H05B 2203/016; H05B 2214/04

(57) ABSTRACT

The present invention relates to a heating element composition capable of three-dimensional molding and a film heater formed therefrom. Specifically, the present invention relates to a heating element composition capable of three-dimensional molding and a film heater formed therefrom, wherein the heating element composition has high extensibility and excellent high temperature durability which is in a conflicting relationship with extensibility, so that mechanical damage such as cracks during stretching can be suppressed, has the characteristic of being stably maintained in a molded shape rather than being restored to an original shape after molding, like conventional stretchable materials, can minimize the change rate of resistance when deformed by three-dimensional molding, can be cured at 150° C. or less, and can form a heating element by various printings or coatings so as to be applied to various film heaters.

### TECHNICAL FIELD

The present invention relates to a heating element composition capable of three-dimensional molding and a film heater formed therefrom. Specifically, the present invention relates to a heating element composition capable of three-dimensional molding which has high extensibility while having high temperature durability, which is in conflict with extensibility, so that mechanical damage such as cracking upon stretching may be suppressed. The heating element composition possesses the characteristic of being stably maintained in a molded shape rather than being restored to an original shape after molding, as is the case with a conventional stretchable material. In addition, the heating element composition is capable of minimizing a change rate of resistance when deformed by three-dimensional molding, and being cured at 150° C. or less so that the heating element composition is applicable to various film heaters because a heating element can be formed by various printings or coatings. Further, the present invention relates to a film heater formed from the heating element composition capable of three-dimensional molding.

### BACKGROUND ART

A film heater is a heater that is manufactured by printing or coating an electrode and a heating element connected to the electrode on a flexible polymer film, and provides a sense of warmth to a subject as the film heater is heated by the resistance the film heater possesses while current flows through the heating element connected to the electrode when power is applied to the electrode, and it has the advantage of being thin in thickness, being able to be manufactured on a large surface, and providing a rapid sense of warmth with low power, and therefore the film heater has recently been applied in various forms to household appliances such as water heaters and sterilizers, automobiles, buildings, etc.

However, it is difficult to attach a conventional film heater to a three-dimensional structure because of its two-dimensional shape, so it is necessary to attach the conventional film heater to the structure by making a cut such as a V-cut, which causes difficulties in assembly or causes failures in environmental tests.

In addition, the conventional film heater has a problem that it is difficult to use at a high temperature of 150° C. or higher due to insufficient high temperature durability of the material. The conventional film heater requires curing at a limited temperature, or the heating element may be formed by a limited printing method or coating method, resulting in a narrow application range. In particular, elongation of the material inevitably occurs during three-dimensional molding. This elongation may cause mechanical damage to the heating element, such as cracks, and furthermore, a sudden change in resistance of the heating element may occur, resulting in a significant decrease in heating performance.

Conventionally, there are stretchable materials using urethane resin, polydimethylsulfate (PDMS) resin, or the like that possess high extensibility, but these stretchable materials have the characteristic of restoring to their original shape after molding, thus making it difficult to apply the stretchable materials to film heaters that need to closely adhere to a structure with a three-dimensional shape and stably maintain the molded shape.

Accordingly, there is an acute need for a heating element composition for a film heater capable of three-dimensional molding and a film heater formed therefrom which can have high extensibility while having high temperature durability, which is in conflict with extensibility, so that mechanical damage such as cracking upon stretching can be suppressed. The heating element composition can possesses the characteristic of being stably maintained in a molded shape rather than being restored to an original shape after molding, as is the case with a conventional stretchable material. In addition, the heating element composition is capable of minimizing a change rate of resistance when deformed by three-dimensional molding, and being cured at 150° C. or less so that the heating element composition is applicable to various film heaters because a heating element can be formed by various printings or coatings.

### DISCLOSURE

### Technical Problem

The present invention is directed to providing a heating element composition capable of three-dimensional molding, and a film heater formed therefrom, in which the heating element composition possesses high extensibility while having high temperature durability, which is in conflict with extensibility, so that mechanical damage such as cracking upon stretching can be suppressed.

In addition, the present invention is directed to providing a heating element composition capable of three-dimensional molding and a film heater formed therefrom, in which the heating element composition possesses the characteristic of being stably maintained in a molded shape rather than being restored to an original shape after molding, as is the case with conventional stretchable materials.

Further, the present invention is directed to providing a heating element composition capable of three-dimensional molding in which a change rate of resistance upon deformation by three-dimensional molding can be minimized, and a film heater formed therefrom.

Further, the present invention is directed to providing a heating element composition capable of three-dimensional molding that is capable of being cured at 150° C. or less and may form a heating element by various printings or coatings, and thus applicable to various film heaters.

### Technical Solution

To achieve the above-mentioned objects, the present invention is directed to providing a heating element composition capable of three-dimensional molding, the heating element composition may comprise a binder resin, conductive particles, an adhesion enhancer, and a heat resistance enhancer, in which the adhesion enhancer may comprise polyvinyl acetal, the heat resistance enhancer may comprise silsesquioxane powder, the conductive particles may comprise carbon nanotubes, and the binder resin may comprise one or more selected from the group consisting of a resol-based phenolic resin, an unsaturated polyester resin, and a cresol-based phenolic resin.

Here, the binder resin may comprise a resol-based phenolic resin or a cresol-based phenolic resin, and wherein the heating element composition further comprises a crosslinking agent.

In addition, the crosslinking agent may comprise one or more isocyanate crosslinking agents selected from the group consisting of isophorone diisocyanate, hexamethylene diisocyanate, and norbornane diisocyanate, and the content of the crosslinking agent may be 70 to 120 parts by weight based on 100 parts by weight of the binder resin.

Further, the conductive particles may comprise carbon nanotubes (CNTs), and in which the content of the carbon nanotubes (CNTs) may be 3.5 to 15 wt % based on a total weight of the heating element composition.

Further, the conductive particles may further comprise one or more selected from the group consisting of carbon black, graphite, graphene flakes, and metal particles.

Meanwhile, the polyvinylacetal may comprise polyvinylbutyral (PVB), and in which the content of the polyvinylacetal may be 10 to 100 parts by weight based on 100 parts by weight of the binder resin.

In addition, the silsesquioxane powder may comprise polymethylsilsesquioxane powder, and in which the content of the silsesquioxane powder may be 0.5 to 20 wt % based on a total weight of the heating element composition.

Further, the heating element composition may comprise one or more organic solvents selected from the group consisting of carbitol acetate, butyl carbitol, butyl carbitol acetate, dibutyl ether (DBE), butanol, and octanol.

Meanwhile, the present invention is directed to providing a film heater capable of three-dimensional molding, the film heater may comprise: a base film; a pair of electrodes formed on one surface of the base film and having different polarities; and one or more heating elements connected to each of the pair of electrodes and including carbon nanotubes, in which the base film may comprise a polymer film having a tensile strength of 80 kgf/cm² or more and a modulus of elasticity of 550 to 4,000 MPa.

Here, the polymer film may comprise a film made of one or more polymers selected from the group consisting of polyethylene terephthalate (PET), polycarbonate (PC), polycyclohexylenedimethylene terephthalate (PCT), polyethylene terephthalate glycol (PETG), liquid crystal polymer (LCP), acrylonitrile-butadiene-styrene (ABS), high impact polystyrene (HIPS), polypropylene (PP), and polyvinyl chloride (PVC).

In addition, the heating element may be formed from a heating element composition including a binder resin, conductive particles, an adhesion enhancer, and a heat resistance enhancer, the adhesion enhancer may comprise polyvinyl acetal, the heat resistance enhancer may comprise silsesquioxane powder, the conductive particles may comprise carbon nanotubes, and the binder resin may comprise one or more selected from the group consisting of a resol-based phenolic resin, an unsaturated polyester resin, and a cresol-based phenolic resin.

Here, the binder resin may comprise a resol-based phenolic resin or a cresol-based phenolic resin, and the heating element composition may further comprise a crosslinking agent.

In addition, the crosslinking agent may comprise one or more isocyanate crosslinking agents selected from the group consisting of isophorone diisocyanate, hexamethylene diisocyanate, and norbornane diisocyanate, and the content of the crosslinking agent may be 70 to 120 parts by weight based on 100 parts by weight of the binder resin.

Further, the conductive particles may comprise carbon nanotubes (CNTs), and the content of the carbon nanotubes (CNTs) may be 3.5 to 15 wt % based on a total weight of the heating element composition.

Here, the conductive particles may further comprise one or more selected from the group consisting of carbon black, graphite, graphene flakes, and metal particles.

Meanwhile, the polyvinylacetal may comprise polyvinylbutyral (PVB), and the content of the polyvinylacetal may be 10 to 100 parts by weight based on 100 parts by weight of the binder resin.

In addition, the silsesquioxane powder may comprise polymethylsilsesquioxane powder, and the content of the silsesquioxane powder may be 0.5 to 20 wt % based on a total weight of the heating element composition.

Further, the heating element composition may comprise one or more organic solvents selected from the group consisting of carbitol acetate, butyl carbitol, butyl carbitol acetate, dibutyl ether (DBE), butanol, and octanol.

Further, the pair of electrodes may be made of one or more conductive metals selected from the group consisting of silver (Ag), aluminum (Al), copper (Cu), nickel (Ni), stainless steel, and alloys thereof.

Meanwhile, the other surface of the base film may be further provided with an insulation material or metal plate.

### Advantageous Effects

A heating element composition capable of three-dimensional molding according to the present invention can possess high extensibility through a specific combination of a binder resin and an additive, while having high temperature durability, which is in conflict with extensibility, so that mechanical damage such as cracking upon stretching is suppressed. The heating element composition can possess the characteristic of being stably maintained in the molded shape rather than being restored to an original shape after molding as is the case with conventional stretchable materials. Further, the heating element composition can minimize the change rate of resistance when deformed by three-dimensional molding, and can be cured at 150° C. or less, and a heating element can be formed by various printings or coatings, thereby exhibiting an excellent effect applicable to various film heaters.

### DESCRIPTION OF DRAWINGS

FIG. 1 schematically illustrates a cross-sectional structure of one embodiment of a film heater capable of three-dimensional molding according to the present invention.

FIG. 2 schematically illustrates a cross-sectional structure of another embodiment of a film heater capable of three-dimensional molding according to the present invention.

FIG. 3 is a photograph of a two-dimensional film heater and a three-dimensional molded film heater of Example 1.

FIG. 4 is an optical image of a heating portion/electrode portion interface for the three-dimensional molded film heater of Example 1 and an optical image of a surface for a three-dimensional molded film heater of Comparative Example 1.

FIG. 5 is a photograph taken with a thermal imaging camera upon heating of the two-dimensional film heater and three-dimensional molded film heater of Example 1.

FIG. 6 schematically illustrates a vacuum thermoforming machine for evaluating three-dimensional moldability in the embodiments.

### MODE FOR DISCLOSURE

Hereinafter, exemplary embodiments of the present invention will be described in detail. However, the present invention is not limited to the exemplary embodiments to be described below and may be specified as other aspects. On the contrary, the embodiments introduced herein are provided to make the disclosed content thorough and complete, and sufficiently transfer the spirit of the present invention to those skilled in the art. Like reference numerals indicate like constituent elements throughout the specification.

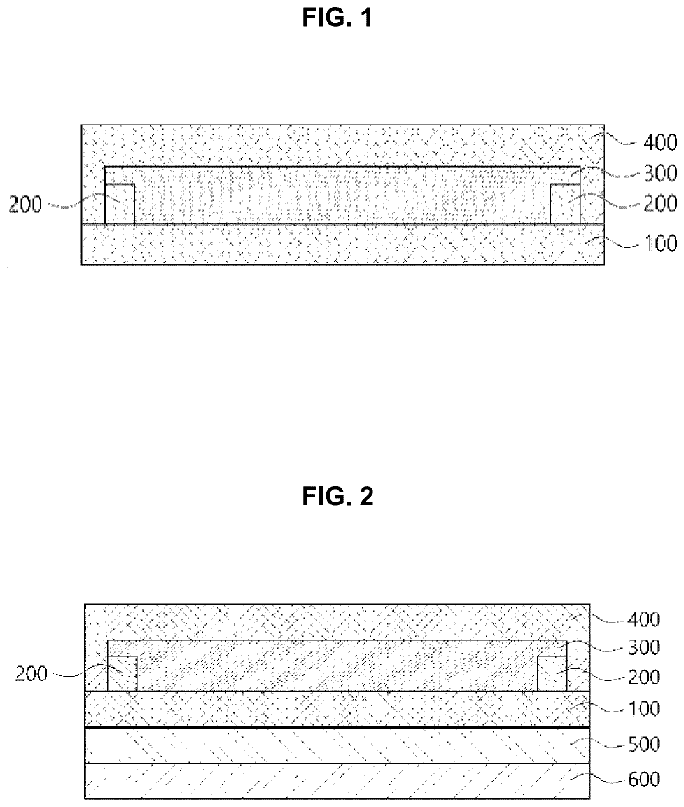

FIG. 1 schematically illustrates a cross-sectional structure of one embodiment of a film heater capable of three-dimensional molding according to the present invention.

As illustrated in FIG. 1, a film heater capable of three-dimensional molding according to the present invention may be provided with a pair of electrodes 200 having different polarities formed on one surface of a base film 100 and one or more heating elements 300 connected to each of the pair of electrodes 200.

Accordingly, when power is applied to the pair of electrodes 200 from the outside, current flows through one or more heating elements 300 connected to each of the pair of electrodes 200, which are heated by the resistance possessed by the heating elements 300 to provide a sense of warmth to a subject. Here, when the one or more heating elements 300 comprises a plurality of heating elements, the plurality of heating elements may be connected in series or in parallel with each other.

The base film 100 is required to have the characteristics of high extensibility and shape retention after molding to enable three-dimensional molding, and to have high temperature durability to endure the high temperature heating of the heating element 300. The base film 100 may be a polymer film having a tensile strength of 80 kgf/cm² or more, such as 80 to 750 kgf/cm², preferably 100 to 560 kgf/cm², a modulus of elasticity of 550 to 4,000 MPa, more preferably 590 to 2,000 MPa, and a glass transition temperature of 150° C. or less, such as −30 to 150° C., more preferably 80 to 100° C., in order to satisfy the aforementioned properties. The polymer film may be, for example, a film made of polyethylene terephthalate (PET), polycarbonate (PC), polycyclohexylenedimethylene terephthalate (PCT), polyethylene terephthalate glycol (PETG), liquid crystal polymer (LCP), acrylonitrile-butadiene-styrene (ABS), high impact polystyrene (HIPS), polypropylene (PP), polyvinyl chloride (PVC), and the like.

Meanwhile, the electrode 200 may be made of a conductive metal, such as silver (Ag), aluminum (Al), copper (Cu), nickel (Ni), stainless steel, and alloys thereof, and may be formed by processed a metal film laminated to the base film into a predetermined pattern by a process such as etching by photolithography.

The heating element 300 may be formed by printing or coating of a heating element composition including a binder resin, a crosslinking agent, conductive particles, an adhesion enhancer, a heat resistance enhancer, an organic solvent, and the like, and such heating element may have a change rate of resistance of 15% or less at 15% elongation, preferably a change rate of resistance of 28% or less at 20% elongation. Here, the change rate of resistance means a ratio of an increase in resistance after stretching to an initial resistance on the basis of resistance before stretching.

The binder resin, as a base material of the heating element composition, possesses moldability so that the heating element can be formed by a printing or coating method such as screen, gravure, comma coating, spray coating, slot die coating, etc., and may possess the characteristics of extensibility and shape retention after molding so that the heating element formed from the heating element composition and the film heater including the heating element can be molded three-dimensional, and, despite having excellent extensibility, has excellent high temperature durability so that the binder resin can be used at a high temperature of 200° C. or higher. Since the binder resin can be cured at 150° C. or less, the binder resin may be applicable to various plastic films such as polyethylene terephthalate (PET), polycarbonate (PC), polyethylene naphthalate (PEN), polyimide (PI), liquid crystal polymer (LCP), acrylonitrile-butadiene-styrene (ABS), high impact polystyrene (HIPS), polypropylene (PP), polyvinyl chloride (PVC), and the like.

The binder resin may comprise one or more types selected from the group consisting of, for example, a resol-based phenolic resin, an unsaturated polyester resin, a cresol-based phenolic resin, and the like, preferably a resolvent phenolic resin.

Here, when the binder resin is a resol-based phenolic resin or a cresol-based phenolic resin or both, the heating element composition may further comprise a crosslinking agent. The crosslinking agent may improve the characteristics of shape retention after molding, high temperature durability, and the like of the heating element formed from the heating element composition through crosslinking of the binder resin after printing or coating of the heating element composition, and may comprise, for example, an isocyanate crosslinking agent such as isophorone diisocyanate, hexamethylene diisocyanate, norbornane diisocyanate, and the like.

The isocyanate crosslinking agent is inactive at a predetermined temperature or lower and thus has excellent storage stability and workability such that no crosslinking reaction occurs upon storage, and may be comprised in an amount of 70 to 120 parts by weight based on 100 parts by weight of the binder resin.

Here, when the content of the crosslinking agent is less than 70 parts by weight, the heat resistance of the heating element composition decreases due to the low crosslinking degree of the binder resin. In contrast, when the content of the crosslinking agent is more than 120 parts by weight, the brittleness of the heating element formed by printing or coating of the heating element composition is excessive, resulting in a decrease in extensibility, and mechanical defects may occur in three-dimensional molding.

The conductive particles may comprise carbon nanotubes (CNTs). Since the carbon nanotube has a large aspect ratio, a distance between the carbon nanotube particles may be maintained even upon stretching of the heating element formed from the heating element composition, so that the heating element may minimize the change rate of resistance even upon stretching or three-dimensional molding.

The content of the carbon nanotubes (CNTs) may be 3.5 to 15 wt % based on the total weight of the heating element composition, and when the content of the carbon nanotubes (CNTs) is less than 3.5 wt %, the resistance of the heating element is high, the change rate of resistance upon stretching is large, and the viscosity of the heating element composition is too low, resulting in poor workability such as printing or coating. In contrast, when the content of the carbon nanotubes (CNTs) is more than 15 wt %, the dispersion of the carbon nanotubes (CNTs) in the heating element composition is difficult, resulting in a decrease in resistance, and the change rate of resistance may increase, especially when the heating element is stretched or three-dimensional molded.

In addition to the carbon nanotubes (CNTs), the conductive particles may further comprise conductive auxiliary particles such as carbon black, graphite, graphene flakes, metal particles, etc., to further reduce the change rate of resistance upon stretching or three-dimensional molding of the heating element, in which the content of the conductive auxiliary particles may be 1 to 10 wt % based on the total weight of the heating element composition.

The adhesion enhancer may perform a function of further enhancing the flexibility and adhesion of the heating element formed from the heating element composition, thereby further facilitating stretching or three-dimensional molding of the heating element. The adhesion enhancer may comprise a polyvinylacetal synthesized from a polyvinyl alcohol and an aldehyde, the aldehyde may comprise one or more selected from the group consisting of n-butyl aldehyde, isobutyl aldehyde, n-barrel aldehyde, 2-ethyl butyl aldehyde, n-hexyl aldehyde, and the like, and the adhesion enhancer may preferably comprise polyvinylbutyral (PVB).

The content of the adhesion enhancer may be 10 to 100 parts by weight based on 100 parts by weight of the binder resin. When the content of the adhesion enhancer is less than 10 parts by weight, the flexibility, adhesion, etc. of the heating element composition may be insufficient. In contrast, when the content of the adhesion enhancer is more than 100 parts by weight, the viscosity of the heating element composition may be excessive, and the printing and coating characteristics may be greatly degraded.

The heat resistance enhancer performs a function of further improving the heat resistance of the heating element composition, i.e., high temperature durability and flexibility, thereby enabling the heating element composition to be applied to various plastic films and facilitating stretching or three-dimensional molding of the heating element.

The heat resistance enhancer may comprise a silsesquioxane powder, preferably a polyalkylsilsesquioxane powder such as polymethylsilsesquioxane, polypropylsilsesquioxane, and the like, and the content of the heat resistance enhancer may be 0.5 to 20 wt % based on the total weight of the heating element composition.

Here, when the content of the heat resistance enhancer is less than 0.5 wt %, cracking may occur frequently upon stretching of the heating element formed from the heating element composition. In contrast, when the content of the heat resistance enhancer is more than 20 wt %, the viscosity of the heating element composition may be excessive, and the membrane characteristics of the heating element formed from the heating element composition may be degraded.

The heating element composition may further comprise an organic solvent, such as carbitol acetate, butyl carbitol, butyl carbitol acetate, dibutyl ether (DBE), butanol, octanol, or the like, to adjust the rheology of the viscosity, thixotropic index, or the like, and the content of the organic solvent may be 35 to 50 wt % based on the total weight of the heating element composition.

The heating element composition may possess high extensibility through the combination of the constituent elements described above and the controlled change rate of resistance when stretched thereby, and while having excellent high temperature durability, which is in conflict with extensibility, so that mechanical damage such as cracking when stretched is suppressed. In addition, the heating element composition possesses the characteristic of being stably maintained in a molded shape rather than being restored to an original shape after molding, as is the case with conventional stretchable materials, and may have a minimized change rate of resistance when deformed by three-dimensional molding, and may be cured at 150° C. or less, and may form a heating element by various printings or coatings, thus exhibiting an excellent effect applicable to various film heaters.

In addition, the heating element formed from the heating element composition may be implemented with a resistivity of 10⁻¹ to 1×10⁻³ Ω cm, and has no problem heating up to 250° C. or more in consideration of the resistivity, thickness, area, and applied power of a coating film of the printed heating element. However, the conventional stretchable material using urethane resin or polydimethylsulfate (PDMS) resin cannot be used as a binder resin for the heating element to be three-dimensional molded because the heat resistance is greatly reduced, which causes a change rate of resistance of the heating element or damage to the coating film.

FIG. 2 schematically illustrates a cross-sectional structure of another embodiment of a film heater capable of three-dimensional molding according to the present invention.

As illustrated in FIG. 2, an insulation material 400 and a metal plate 500 provided underneath the insulation material 400 may be formed on the other surface of the base film 100. The insulation material 400 prevents thermal energy generated by the heating of the heating element 300 from being lost mediated through the base film 100 to the other surface of the base film 100, thereby performing a function of ensuring that the heating element 300 supplies sufficient thermal energy to the subject. For example, the insulation material 400 may be provided with a spacer insulation material, such as an expanded polystyrene foam insulation material or a honeycomb insulation material that is filled with air inside to form an air insulation layer.

When the insulation material 400 is the expanded polystyrene foam insulation material, the metal plate 500 may perform a function of protecting against impact or pressure from the outside of the expanded polystyrene foam insulation material, and when the insulation material 400 is the spacer insulation material, the metal plate 500 may perform a function of sealing the internal empty space of the spacer while simultaneously acting as a reflector to prevent further heat loss by reflecting radiant light from the other surface of the base film 100 back to the base film 100.

The film heater capable of three-dimensional molding according to the present invention possesses high extensibility through the combination of the structure and material described above, and simultaneously has high temperature durability, which is in conflict with extensibility, so that mechanical damage such as cracking upon stretching may be suppressed. In addition, the film heater has the characteristic of being stably maintained in a molded shape rather than being restored to an original shape after molding, as is the case with conventional stretchable materials, and has a minimized change rate of resistance of the heating element when deformed by three-dimensional molding, thereby exhibiting an excellent effect of providing a rapid sense of warmth to a subject through uniform heating.

### EXAMPLES

### 1. Manufacturing Example

### 1) Manufacturing Example of Heating Element Paste Composition

A heating element composition was manufactured with the constituent elements and contents listed in Table 1 below. Specifically, the conductive particles are added to an organic solvent with a dispersant and sonicated for 60 minutes to prepare a conductive carbon dispersion. Next, the binder resin and other additives were prepared into a master batch (M/B) through mechanical stirring or mechanical kneading capable of rotation and revolution, and the heating element paste composition was prepared by kneading the binder resin and other additives together with the conductive carbon dispersion through mechanical stirring and then thoroughly kneading using a three-roll mill. The unit of content listed in Table 1 below is wt %.

TABLE 1

| | Example | | | | | | | | Comparative Example | | | | | | |
|---|---|---|---|---|---|---|---|---|---|---|---|---|---|---|---|
| | 1 | 2 | 3 | 4 | 5 | 6 | 7 | 8 | 1 | 2 | 3 | 4 | 5 | 6 | 7 |
| Binder resin 1 | 15 | | | 15 | 15 | 15 | 12 | | 15 | | | 15 | 15 | | |
| Binder resin 2 | | 15 | | | | | | | | 15 | | | | | |
| Binder resin 3 | | | 30 | | | | | 25 | | | 30 | | | | |
| Binder resin 4 | | | | | | | | | | | | | | 30 | |
| Binder resin 5 | | | | | | | | | | | | | | | 30 |
| Crosslinking | 15 | 15 | 0 | 11 | 18 | 15 | 12 | 0 | 15 | 15 | 0 | 20 | 15 | 0 | 0 |
| agent | | | | | | | | | | | | | | | |
| Adhesion | 15 | 15 | 15 | 10 | 8 | 12 | 8 | 10 | 15 | 15 | 15 | 10 | 20 | 0 | 0 |
| enhancer | | | | | | | | | | | | | | | |
| Conductive | 6 | 6 | 6 | 8 | 3.5 | 15 | 6 | 5 | 6 | 6 | 6 | 8 | 3.5 | 8 | 8 |
| Particle 1 | | | | | | | | | | | | | | | |
| Conductive | 0 | 0 | 0 | 5 | 8 | 0 | 0 | 5 | 0 | 0 | 0 | 5 | 5 | 5 | 5 |
| Particle 2 | | | | | | | | | | | | | | | |
| Heat resistance | 4 | 4 | 4 | 2 | 6 | 0.5 | 10 | 3 | 0 | 0 | 0 | 2 | 2 | 4 | 4 |
| enhancer | | | | | | | | | | | | | | | |
| Organic solvent | 42 | 42 | 42 | 45 | 39.5 | 37.5 | 49 | 49 | 46 | 46 | 46 | 36 | 37.5 | 50 | 50 |
| Dispersant | 3 | 3 | 3 | 4 | 2 | 5 | 3 | 3 | 3 | 3 | 3 | 4 | 2 | 3 | 3 |

Binder resin 1: Resol-based phenol
Binder resin 2: Cresol-based phenol
Binder resin 3: Unsaturated polyester
Binder resin 4: Polyacrylate
Binder resin 5: Polyurethane
Crosslinking agent: Isocyanate
Adhesion enhancer: Polyvinyl butyral
Conductive particle 1: Carbon nanotube
Conductive particle 2: Graphite
Heat resistance enhancer: Polymethylsilsesquioxane
Organic solvent: Butyl carbitol
Dispersant: BYK dispersant

### 2) Manufacturing Example of Film Heater

A two-dimensional film heater was prepared by printing and drying each of the heating element paste compositions of Examples and Comparative Examples on a polycyclohexylenedimethylene terephthalate (PCT) film using a screen printer, and printing and drying a silver (Ag) electrode paste. Next, the prepared two-dimensional film heater was molded into three-dimension using a vacuum molding machine to prepare a three-dimensional molded film heater.

### 2. Evaluating Properties

### 1) Evaluation of Sheet Resistance and Change Rate of Resistance Upon Stretching

A heating element specimen were prepared by screen printing and curing the heating element paste composition according to each of Examples and Comparative Examples in a size of 3 cm×3 cm, and the sheet resistance of the heating element specimen was measured using a 4-terminal measurement method (Loresta-GX).

In addition, a heating element specimen was prepared by screen printing and curing the heating element paste composition according to each of Examples and Comparative Examples in a size of 2.5 cm×5 cm and printing silver (Ag) electrodes on both ends, and the resistance of the specimen in the stretched state after 15% and 20% elongation was measured using a universal tensile testing equipment, and the change rate of resistance corresponding to the fraction of the incremental resistance based on the resistance before stretched was calculated.

Furthermore, thermal imaging of the film heater before and after three-dimensional molding was performed to evaluate the uniformity of heating due to resistance changes.

### 2) Evaluating Mechanical Defects

In the three-dimensionally molded film heater having the heating element formed from the heating element paste composition according to each of Examples and Comparative Examples, the surface of the heating element was observed by electron microscopy (SEM) to identify whether the heating element was cracked.

### 3) Evaluating Three-Dimensional Moldability

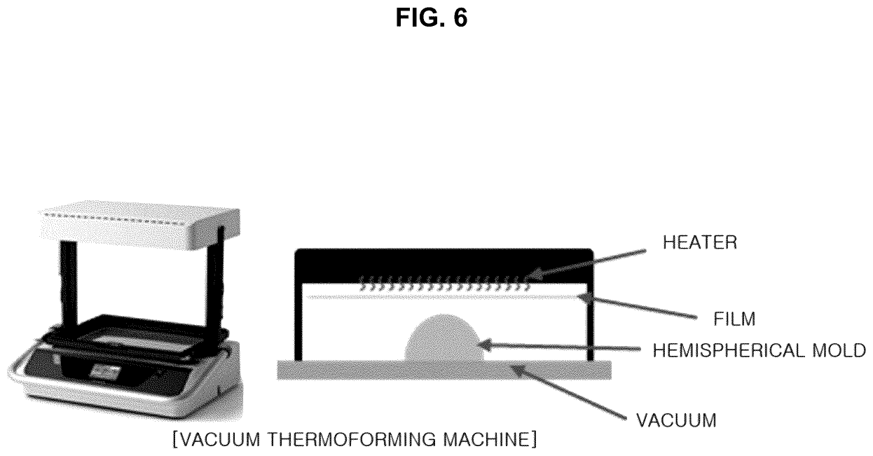

Using the vacuum thermoforming machine illustrated in FIG. 6, the specimen of the film heater according to each of Examples and Comparative Examples is mounted in the position of the film illustrated in FIG. 6, and then the specimen is preheated to 200° C. and pulled in a downward direction with a hemispherical mold to be molded. Moldability was evaluated by observing whether the film heater specimen was mechanically damaged after molded and analyzing electrical properties and thermal behavior.

### 4) Evaluating Usable Temperature

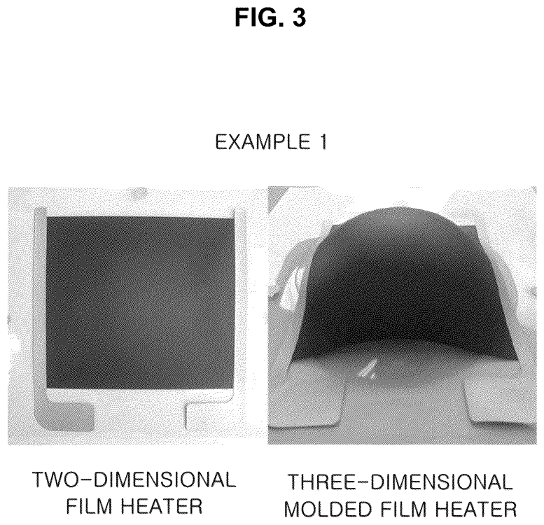

To evaluate the 200° C. usability, the two-dimensional film heater specimen in FIG. 3 was prepared by printing and drying each heating element composition of Examples and Comparative Examples on a polyimide substrate using a screen printer, and then the specimen was subjected to a heating test by applying a voltage to the specimen to generate 200° C. heating. Specimens that smoke or pyrolyze during testing are rejected as failures immediately. A normally functioning film heater specimen was subjected to an intermittent life test of 1,000 on/off cycles from room temperature to 200° C., left for 1 hour and then restarted, and was determined to be usable when the terminal resistance and heating temperature were maintained within 5% compared to before the test.

The results of the evaluation are shown in Table 2 and FIGS. 3 to 5 below.

TABLE 2

| | | | 15% | 20% | | | | |
|---|---|---|---|---|---|---|---|---|
| | | | elongation | elongation | Presence | | | |
| | | Sheet | Change rate | Change rate | or | Three- | Usable | |
| | | resistance | of resistance | of resistance | absence | dimensional | temperature | |
| | | (Ω/cm²) | (%) | (%) | of crack | moldability | (° C.) | Others |
| EXAMPLE | 1 | 74.2 | 4.4 | 17.8 | No | Excellent | 200↑ | |
| | 2 | 78.6 | 6.7 | 18.5 | No | Excellent | 200↑ | |
| | 3 | 77.8 | 5.1 | 18.4 | No | Excellent | 200↑ | |
| | 4 | 40.82 | 4.3 | 15.2 | No | Excellent | 200↑ | |
| | 5 | 62.7 | 10.2 | 22.5 | No | Excellent | 200↑ | |
| | 6 | 42.5 | 11.8 | 24.5 | No | Excellent | 200↑ | |
| | 7 | 87.9 | 14.2 | 27.5 | No | Excellent | 200↑ | |
| | 8 | 47.5 | 5.7 | 19.2 | No | Excellent | 200↑ | |
| C. | 1 | 62.8 | 21.8 | 41.5 | Yes | Poor | 200↑ | |
| EXAMPLE | 2 | 68.7 | 22.4 | 55.5 | Yes | Poor | 200↑ | |
| | 3 | 70.4 | 24.1 | 54.2 | Yes | Poor | 200↑ | |
| | 4 | 38.2 | 28.2 | 35.2 | Yes | Poor | 200↑ | |
| | 5 | 55.7 | 14.2 | 21.5 | No | Poor | 200↑ | X |
| | 6 | 47.5 | 14.8 | 27.4 | Yes | Moderate | 150↓ | |
| | 7 | 55.2 | 13.2 | 29.5 | No | Moderate | 150↓ | |

X: Poor printability & Excessive viscosity

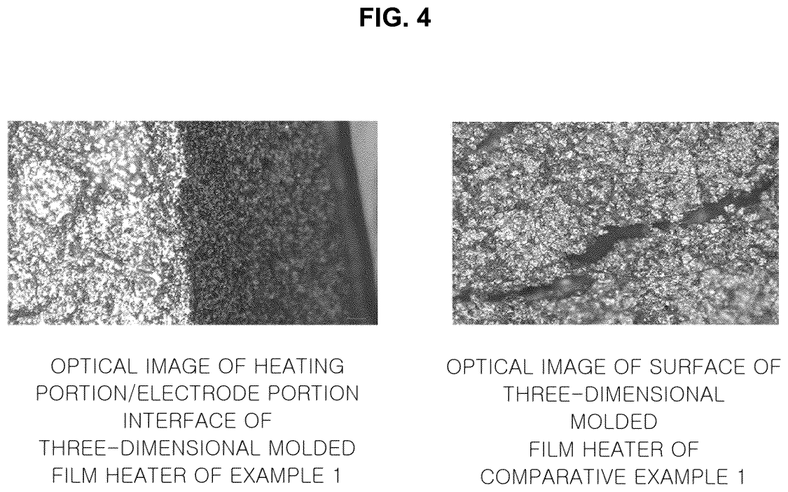

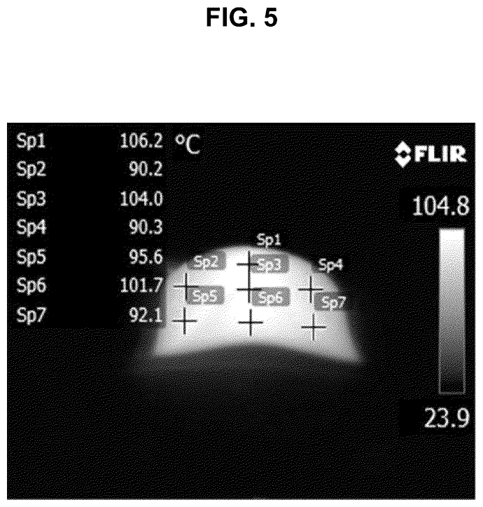

As described above in Table 2, the heating element formed from the heating element composition of Examples 1 to 8 according to the present invention has a controlled change rate of resistance of 15% or less at 15% elongation, and a further controlled change rate of resistance of 28% or less at 20% elongation, while having excellent mechanical strength, such as not cracking even during three-dimensional molding, and excellent shape retention characteristics after three-dimensional molding, as illustrated in FIGS. 3 and 4. In addition, the heating element can be applied in an environment of 200° C. or higher due to the excellent high temperature durability. Further, as illustrated in FIG. 5, the three-dimensional molded film heater provided with the heating element formed from the heating element composition of Example 1 was found to have uniform heating performance over the entire area with a heating uniformity of 94% or more even after three-dimensional molding, which means that the resistance of the heating element was maintained even when stretched by three-dimensional molding and mechanical damage such as cracking was suppressed. Meanwhile, it was confirmed that the heating element composition of Co. (Comparative) Examples 1 to 3 did not comprise a heat resistance enhancer, resulting in a significant increase in the change rate of resistance when the heating element was stretched, and insufficient high temperature durability, which caused mechanical defects such as cracks to occur during three-dimensional molding as illustrated in FIG. 2, and significantly reduced three-dimensional moldability.

It was confirmed that the heating element composition of Co. Example 4 had reduced extensibility due to excessive brittleness of the heating element formed with the crosslinking agent content exceeding the reference, resulting in mechanical defects in three-dimensional molding, and it was confirmed that the heating element composition of Co. Example 5 had significantly reduced printing and coating characteristics due to excessive viscosity of the heating element composition with the adhesion enhancer content exceeding the reference.

In addition, it was confirmed that the heating element composition of Co. Examples 6 and 7 has the problem of being applicable only to a working environment below 150° C. by including a polyacrylate or polyurethane resin having insufficient heat resistance as a binder resin, and further has the problem of cracking during three-dimensional molding and insufficient shape retention characteristics after three-dimensional molding.

While the present invention has been described above with reference to the exemplary embodiments, it may be understood by those skilled in the art that the present invention may be variously modified and changed without departing from the spirit and scope of the present invention disclosed in the claims. Therefore, it should be understood that any modified embodiment that essentially comprises the constituent elements of the claims of the present invention is comprised in the technical scope of the present invention.

1. A heating element composition capable of three-dimensional molding, the heating element composition comprising:
a binder resin;
conductive particles;
an adhesion enhancer; and
a heat resistance enhancer,
wherein the adhesion enhancer comprises polyvinyl acetal,
the heat resistance enhancer comprises silsesquioxane powder,
the conductive particles comprise carbon nanotubes, and
the binder resin comprises one or more selected from the group consisting of a resol-based phenolic resin, an unsaturated polyester resin, and a cresol-based phenolic resin.

2. The heating element composition of claim 1, wherein the binder resin comprises a resol-based phenolic resin or a cresol-based phenolic resin, and
wherein the heating element composition further comprises a crosslinking agent.

3. The heating element composition of claim 2, wherein the crosslinking agent comprises one or more isocyanate crosslinking agents selected from the group consisting of isophorone diisocyanate, hexamethylene diisocyanate, and norbornane diisocyanate, and
wherein the content of the crosslinking agent is 70 to 120 parts by weight based on 100 parts by weight of the binder resin.

4. The heating element composition of claim 1, wherein the conductive particles comprise carbon nanotubes (CNTs), and
wherein the content of the carbon nanotubes (CNTs) is 3.5 to 15 wt % based on a total weight of the heating element composition.

5. The heating element composition of claim 4, wherein the conductive particles further comprise one or more selected from the group consisting of carbon black, graphite, graphene flakes, and metal particles.

6. The heating element composition of claim 1, wherein the polyvinylacetal comprises polyvinylbutyral (PVB), and
wherein the content of the polyvinylacetal is 10 to 100 parts by weight based on 100 parts by weight of the binder resin.

7. The heating element composition of claim 1, wherein the silsesquioxane powder comprises polymethylsilsesquioxane powder, and
wherein the content of the silsesquioxane powder is 0.5 to 20 wt % based on a total weight of the heating element composition.

8. The heating element composition of claim 1, wherein the heating element composition comprises one or more organic solvents selected from the group consisting of carbitol acetate, butyl carbitol, butyl carbitol acetate, dibutyl ether (DBE), butanol, and octanol.

9. A film heater capable of three-dimensional molding, the film heater comprising:
a base film;
a pair of electrodes formed on one surface of the base film and having different polarities; and
one or more heating elements connected to each of the pair of electrodes and including carbon nanotubes,
wherein the base film comprises a polymer film having a tensile strength of 80 kgf/cm² or more and a modulus of elasticity of 550 to 4,000 MPa.

10. The film heater of claim 9, wherein the polymer film comprises a film made of one or more polymers selected from the group consisting of polyethylene terephthalate (PET), polycarbonate (PC), polycyclohexylenedimethylene terephthalate (PCT), polyethylene terephthalate glycol (PETG), liquid crystal polymer (LCP), acrylonitrile-butadiene-styrene (ABS), high impact polystyrene (HIPS), polypropylene (PP), and polyvinyl chloride (PVC).

11. The film heater of claim 9, wherein the heating element is formed from a heating element composition including a binder resin, conductive particles, an adhesion enhancer, and a heat resistance enhancer,
wherein the adhesion enhancer comprises polyvinyl acetal,
the heat resistance enhancer comprises silsesquioxane powder, wherein the conductive particles comprise carbon nanotubes, and
the binder resin comprises one or more selected from the group consisting of a resol-based phenolic resin, an unsaturated polyester resin, and a cresol-based phenolic resin.

12. The film heater of claim 11, wherein the binder resin comprises a resol-based phenolic resin or a cresol-based phenolic resin, and
wherein the heating element composition further comprises a crosslinking agent.

13. The film heater of claim 11, wherein the crosslinking agent comprises one or more isocyanate crosslinking agents selected from the group consisting of isophorone diisocyanate, hexamethylene diisocyanate, and norbornane diisocyanate, and
wherein the content of the crosslinking agent is 70 to 120 parts by weight based on 100 parts by weight of the binder resin.

14. The film heater of claim 11, wherein the conductive particles comprise carbon nanotubes (CNTs), and
wherein the content of the carbon nanotubes (CNTs) is 3.5 to 15 wt % based on a total weight of the heating element composition.

15. The film heater of claim 14, wherein the conductive particles further comprise one or more selected from the group consisting of carbon black, graphite, graphene flakes, and metal particles.

16. The film heater of claim 11, wherein the polyvinylacetal comprises polyvinylbutyral (PVB), and
wherein the content of the polyvinylacetal is 10 to 100 parts by weight based on 100 parts by weight of the binder resin.

17. The film heater of claim 11, wherein the silsesquioxane powder comprises polymethylsilsesquioxane powder, and
wherein the content of the silsesquioxane powder is 0.5 to 20 wt % based on a total weight of the heating element composition.

18. The film heater of claim 11, wherein the heating element composition comprises one or more organic solvents selected from the group consisting of carbitol acetate, butyl carbitol, butyl carbitol acetate, dibutyl ether (DBE), butanol, and octanol.

19. The film heater of claim 9, wherein the pair of electrodes are made of one or more conductive metals selected from the group consisting of silver (Ag), aluminum (Al), copper (Cu), nickel (Ni), stainless steel, and alloys thereof.

20. The film heater of claim 9 or 10, wherein the other surface of the base film is further provided with an insulation material or metal plate.
